(19) United States
(12) Patent Application Publication
(10) Pub. No.: US 2007/0001940 A1
(43) Pub. Date: Jan. 4, 2007

(54) LIGHT-EMITTING DEVICE, CIRCUIT FOR DRIVING THE SAME, AND ELECTRONIC APPARATUS

(75) Inventor: Hiroaki JO, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/423,385

(22) Filed: Jun. 9, 2006

(30) Foreign Application Priority Data
Jul. 4, 2005 (JP) 2005-194641

(51) Int. Cl. G09G 3/30

(52) U.S. Cl. 345/77

(57) ABSTRACT

A light emitting device includes: a plurality of unit circuits each of which includes a driving transistor for generating a driving current corresponding to a potential of a gate and a light emitting element for emitting light having a brightness corresponding to the driving current; a plurality of signal processing units which correspond to the unit circuits; and a designating unit which designates voltages to the signal processing units. Each of the plurality of signal processing units includes: a voltage adjusting unit which variably outputs a voltage to operate the driving transistor in a saturated region in response to a designation by the designating unit; and an output unit which outputs the voltage output from the voltage adjusting unit to the gate of the driving transistor corresponding to the signal processing unit at a time density corresponding to a gray-scale value designated to the light emitting element.

This application claims priority from JP 2005-194641, filed in the Japanese Patent Office on Jul. 4, 2005, the entire disclosure of which is hereby incorporated by reference in its entirety.

### BACKGROUND

1. Technical Field

The present invention relates to a technique for controlling the driving of a light emitting element, such as an organic light emitting diode (hereinafter, referred to as an ‘OLED’).

2. Related Art

There has been proposed a technique for controlling a period of time for which a light emitting element emits light to control the gray-scale level of the light emitting element. For example, JP-A-2002-108285 (see FIG. 1) discloses a display device in which light emitting elements and n-channel transistors (hereinafter, referred to as ‘driving transistors’), each having a source connected to an anode of the light emitting element, are arranged in a matrix. In such a structure, an ON voltage (a voltage to turn on the driving transistor) is applied to the gate of the driving transistor within part of a predetermined period corresponding to a gray-scale value designated to the light emitting element and an OFF voltage (a voltage to turn off the driving transistor is applied to the gate of the driving transistor within the other part of the predetermined period. When the ON voltage is applied to turn on the driving transistor, a current (hereinafter, referred to as a ‘driving current’) to cause the light emitting element to emit light is supplied to the light emitting element through the driving transistor. On the other hand, when the OFF voltage is applied to turn off the driving transistor, the supply of the driving current stops and the light emitting elements are turned off.

However, a variation in characteristics (a threshold voltage or carrier mobility) may occur in the driving transistors due to, for example, a manufacturing process. The variation in characteristics causes different driving currents to flow through the driving transistors even when the same voltage is applied to the gates of the driving transistors. Therefore, this structure has a problem in that the brightness levels of the light emitting elements are different from each other. In general, characteristics (voltage-current characteristics) of the driving transistor or the light emitting element vary according to temperature or over the passage of time. The variation in characteristics may cause the driving current to be varied and the brightness of each light emitting element to vary.

### SUMMARY

An advantage of some aspects of the invention is that it provides a technique capable of making a light emitting element emit light having a predetermined brightness with high accuracy without being affected by various factors, such as a variation in the characteristics of a driving transistor and a variation in the characteristics of the light emitting element.

According to an aspect of the invention, a light emitting device includes: a plurality of unit circuits each of which includes a driving transistor for generating a driving current corresponding to a potential of a gate and a light emitting element for emitting light having a brightness corresponding to the driving current; a plurality of signal processing units which correspond to the unit circuits; and a designating unit which designates voltages to the signal processing units. In addition, each of the plurality of signal processing units includes: a voltage adjusting unit which variables outputs a voltage to operate the driving transistor in a saturated region in response to a designation by the designating unit; and an output unit which outputs the voltage output from the voltage adjusting unit to the gate of the driving transistor corresponding to the signal processing unit at a time density corresponding to a gray-scale value designated to the light emitting element. In the above-mentioned structure, for example, the output unit outputs the voltage output from the voltage adjusting unit to the gate of the driving transistor within part of a unit period corresponding to the gray-scale value designated to the light emitting element. On the other hand, the output unit outputs a voltage to turn off the corresponding driving transistor to the gate of the driving transistor within the other part of the unit period.

According to this structure, it is possible to change the voltage to be output to the gate of the driving transistor at a time density corresponding to the gray-scale value in response to a designation by the designating unit. Therefore, it is possible to control the initial brightness of each light emitting element without being affected by various factors, such as a variation in the characteristics of the driving transistor, by properly selecting a voltage to be designated by the designating unit. In addition, since the driving transistor is operated in the saturated region, it is possible to generate a driving current having a predetermined value even when a variation in the characteristics of each light emitting element over time occurs.

In the light emitting device according to this aspects, preferably, the designating unit designates a voltage corresponding to a characteristic of the driving transistor of each of the unit circuits to the signal processing unit corresponding to the unit circuit. More specifically, preferably, when a common gray-scale value is designated to a first unit circuit and a second unit circuit among the plurality of unit circuits, the designating unit designates different voltages to the signal processing unit corresponding to the first unit circuit and the signal processing unit corresponding to the second unit circuit such that the driving currents generated by the driving transistors of the first unit circuit and the second unit circuit are substantially equal to each other. According to this structure, even when the characteristic values (for example, a threshold voltage, carrier mobility, or on-resistance) of the driving transistor vary over time, it is possible to generate a desired driving current with high accuracy and make each light emitting element emit light having a predetermined brightness. This aspect will be described below as a first embodiment.

Further, it is preferable that the voltage output from the voltage adjusting unit be adjusted on the basis of factors other than the characteristic values of each driving transistor (for example, a second embodiment which will be described below). For example, preferably, the light emitting device further includes a temperature sensor which detects a temperature of each of the unit circuits or an ambient temperature thereof, and the designating unit designates a voltage corresponding to the temperature detected by the temperature sensor. According to this structure, even when the characteristics of the driving transistor or the light emitting element vary according to temperature, it is possible to make each light emitting element emit light having a predetermined brightness, without being affected by the variation in characteristics. In addition, preferably, the light emitting device according to this aspect further includes a time specifying unit (for example, a time specifying unit 32 shown in FIG. 4) which specifies a time length used by the light emitting device, and the designating unit designates a voltage corresponding to the time length specified by the time specifying unit. According to this structure, even when the characteristics of the driving transistor or the light emitting element vary over time, it is possible to make each light emitting element emit light having a predetermined brightness, without being affected by the variation in characteristics.

Further, preferably, the light emitting device according to this aspect further includes a brightness designating unit (for example, a brightness designating unit 33 shown in FIG. 4) which designates the overall brightness of the plurality of light emitting elements, and the designating unit designates a voltage corresponding to the brightness designated by the brightness designating unit. According to this structure, it is possible to reliably adjust the actual brightness of each light emitting element with a simple structure, on the basis of the brightness designated by the brightness designating unit. In addition, in the light emitting device according to this aspect, it is preferable that the designating unit designate a voltage corresponding to the gray-scale value designated to each of the plurality of light emitting elements. For example, the designating unit designates a voltage corresponding to the average value of the gray-scale values of the light emitting elements or the maximum value of the gray-scale values of the light emitting elements. According to this structure, it is possible to easily adjust the brightness of each of the light emitting elements on the basis of the gray-scale value thereof.

Further, in the light emitting device according to this aspect, preferably, the voltage adjusting unit of each of the signal processing units includes: a voltage generating circuit which generates a plurality of voltages having different levels; and a selecting circuit which selects one of the plurality of voltages designated by the designating unit. According to this structure, since any one of a plurality of voltages generated by the voltage generating circuit is selected in response to the designation by the designating unit, it is possible to simplify the structure of a voltage adjusting unit, as compared with a structure in which the voltage output from the voltage adjusting unit is changed in response to the designation by the designating unit.

Further, in the light emitting device according to this aspect, preferably, the designating unit includes a storage unit (for example, a memory 271 shown in FIG. 1) which stores a voltage to be output by the voltage adjusting unit, and the designating unit designates a voltage to each of the signal processing units on the basis of contents stored in the storage unit. According to this structure, it is possible to reliably and easily adjust a voltage to be output by the voltage adjusting unit by properly updating contents stored in the storage unit.

According to another aspect of the invention, a light emitting device includes: a plurality of driving transistors each of which generates a driving current corresponding to a potential of a gate; a plurality of light emitting elements each of which emits light with a brightness corresponding to the driving current; a designating unit which designates a voltage; a plurality of voltage adjusting units each of which variably outputs a voltage to operate the driving transistor in a saturated region in response to a designation by the designating unit; and a plurality of output units each of which outputs the voltage output from the voltage adjusting unit to the gate or the driving transistor at a time density corresponding to a gray-scale value designated to the light emitting element.

The light emitting device of the invention is used for various kinds of electronic apparatuses. A typical example of the electronic apparatus is an apparatus using the light emitting device as a display device. This kind of electronic apparatus includes a personal computer and a cellular phone. In addition, the light emitting device of the invention can be applied to devices other than an image display device. For example, the light emitting device can be used an exposure device (an exposure head) for forming a latent image on an image carrier, such as a photoreceptor drum, by radiation of light beams.

According to still another aspect of the invention, there is provided a circuit which drives a light emitting device including a plurality of unit circuits each having a driving transistor for generating a driving current corresponding to a potential of a gate and a light emitting element for emitting light having a brightness corresponding to the driving current. The driving circuit includes: a plurality of signal processing units that correspond to the unit circuits; and a designating unit that designates voltages to the signal processing units. Each of the plurality of signal processing units includes: a voltage adjusting unit which variably outputs a voltage to operate the driving transistor in a saturated region in response to a designation by the designating unit; and an output unit which outputs the voltage output from the voltage adjusting unit to the gate of the driving transistor corresponding to the signal processing unit at a time density corresponding to a gray-scale value designated to the light emitting element. The light emitting device driving circuit can also obtain the same effects as those obtained from the light emitting device of the invention.

### BRIEF DESCRIPTION OF THE DRAWINGS

The invention will be described with reference to the accompanying drawings, wherein like numbers refer to like elements.

FIG. 1 is a block diagram illustrating the structure of a light emitting device according to a first embodiment of the invention.

FIG. 2 is a timing chart illustrating the relationship between gray-scale data and the waveform of a pulse signal.

FIG. 3 is a circuit diagram illustrating the structure of a level shifter.

FIG. 4 is a block diagram illustrating the structure of a light emitting device according to a second embodiment of the invention.

FIG. 5 is a circuit diagram illustrating the structure of a signal processing circuit.

FIGS. 6A and 6B are circuit diagrams illustrating the structures of n-channel and p-channel driving transistors, respectively.

FIG. 7 is a perspective view illustrating an example of an electronic apparatus according to the invention.

FIG. 8 is a perspective view illustrating another example of an electronic apparatus according to the invention.

FIG. 9 is a perspective view illustrating still another example of an electronic apparatus according to the invention.

### DESCRIPTION OF EXEMPLARY EMBODIMENTS

### First Embodiment

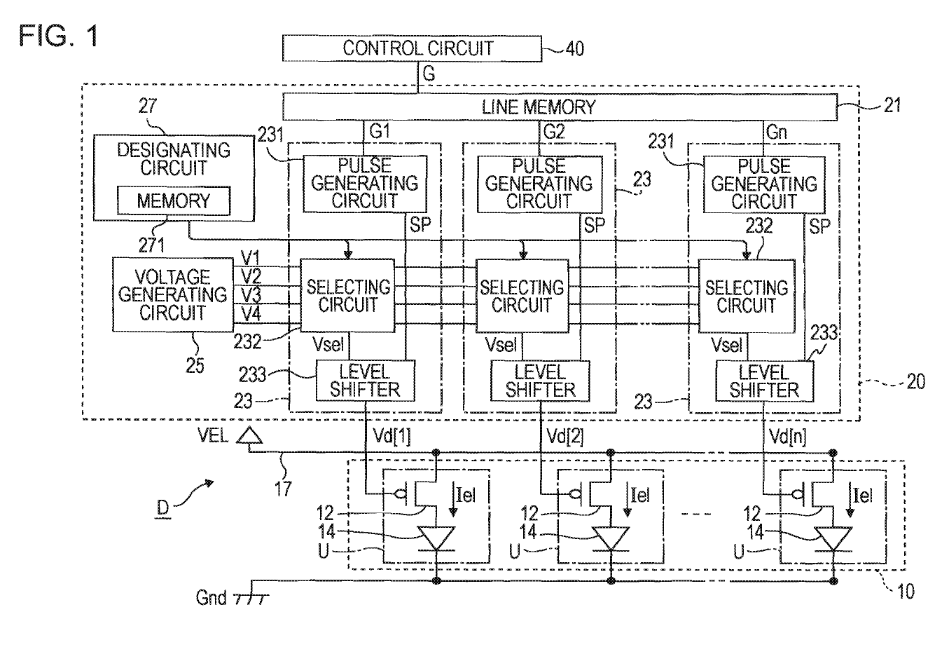

FIG. 1 is a block diagram illustrating the structure of a light emitting device according to a first embodiment of the invention. A light emitting device D of this embodiment is used as an exposure head for exposing a photoreceptor in an image forming apparatus (a printing apparatus) which forms a latent image by exposing the photoreceptor. As shown in FIG. 1, the light emitting device D includes a light emitting unit 10 having n unit circuits U (n is a natural number) arranged in a row along a scanning line, a driving circuit 20 for driving the unit circuits U, and a control circuit 40 for controlling the operation of the driving circuit 20.

Each of the n unit circuits U forming the light emitting unit 10 includes a driving transistor 12 and a light emitting element 14. The light emitting element 14 is a current driven type element for emitting light having brightness corresponding to a driving current Iel. For example, the light emitting element 14 is an OLED element having a light emitting layer formed of an organic EL material interposed between an anode and a cathode. The cathode of the light emitting element 14 is connected to the ground (Gnd). A latent image corresponding to an image (a toner image) to be formed on a recording medium, such as a sheet, is formed on the surface of the photoreceptor by selectively operating these light emitting elements 14. Meanwhile, the driving transistor 12 is a p-channel transistor (for example, a thin film transistor) for generating the driving current Iel corresponding to the potential of a gate, and has a drain connected to the anode of the light emitting element 14. A source of each driving transistor 12 is connected to a power line 17 to which a high potential (hereinafter, referred to as a ‘power sup ply voltage’) VEL of a power supply is applied.

The control circuit 40 supplies various signals, such as a clock signal, to control the operational timing of the driving circuit 20 and outputs, to the driving circuit 20, gray-scale data G for designating a gray-scale value of each light emitting element 14. In this embodiment, the gray-scale data G is 4-bit digital data for designating any one of 16 gray-scale levels from a gray-scale value 0 to a gray-scale value 15. The driving circuit 20 drives each unit circuit U such that the corresponding light emitting element 14 emits light at a gray-scale (brightness) level corresponding to the gray-scale data G. As shown in FIG. 1, the driving circuit 20 includes a line memory 21 for storing the gray-scale data G, n signal processing circuits 23 corresponding to the total number of light emitting elements 14, a voltage generating circuit 25, and a designating circuit 27.

The line memory 21 receives gray-scale data G (G1, G2, . . . , Gn) corresponding to n light emitting elements 14 and sequentially stores them. Then, n gray-scale data G stored in the line memory 21 are simultaneously read out at the time designated by the control circuit 40 and then output to the corresponding signal processing circuits 23. Gray-scale data Gi designating the gray-scale value of an i-th light emitting element 14 (i is an integer in the range 1≦i≦n) is input to an i-th signal processing circuit 3 from the left side of FIG. 1.

The signal processing circuits 23 output data signals Vd (Vd[1], Vd[2], . . . , Vd[n]) to the corresponding unit circuits U. The data signal Vd[1] causes the i-th light emitting element 14 to emit light for a period of time corresponding to the gray-scale data Gi of a predetermined period P (hereinafter, referred to as a ‘unit period’) and causes the light emitting element 14 to be turned off-for the other period of time.

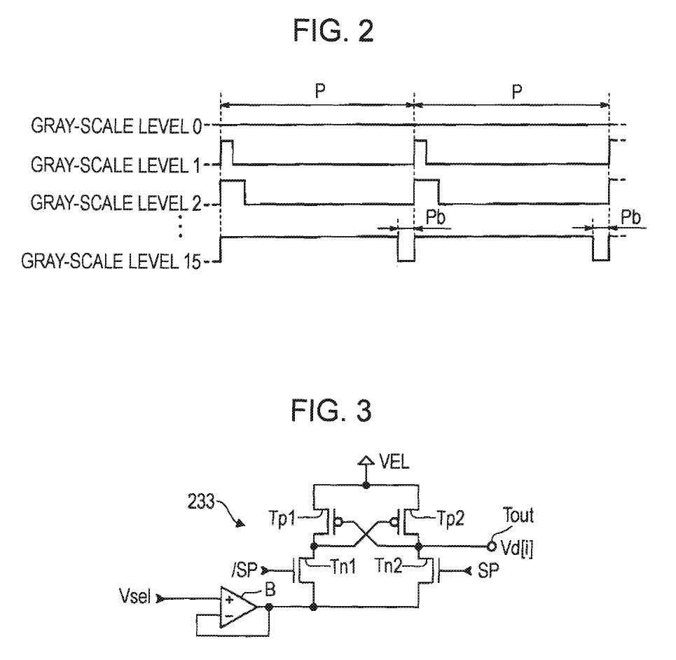

As shown in FIG. 1, each signal processing circuit 23 includes a pulse generating circuit 231, a selecting circuit 232, and a level shifter 233. The pulse generating circuit 231 generates a pulse signal SP having a pulse width corresponding to the gray-scale data Gi. FIG. 2 is a timing chart illustrating the relationship between the gray-scale values (‘0’ to ‘15’) designated by the gray-scale data Gi and the pulse signal SP generated by the pulse generating circuit 231. As shown in FIG. 2, the pulse signal SP is generated such that, as the gray-scale value designated by the gray-scale data Gi becomes larger, part of the unit period P where a high level (that is, a pulse width) is maintained becomes longer. However, when the smallest gray-scale value ‘0’ is designated, the pulse signal SP is maintained at a low level over the entire unit period P. The pulse signal SP corresponding to the largest gray-scale value ‘15’ is maintained at a high level within part of the unit period P other than a blocking period Pb. However, the pulse signal SP corresponding to the largest gray-scale value ‘15’ may be maintained at a high level over the entire unit period P.

The voltage generating circuit 25 shown in FIG. 1 generates four different voltages V1 to V4 by means of, for examples resistance division. The voltages V1 to V4 are higher than a ground voltage Gnd and lower than the power supply voltage VEL. The voltages V1 to V4 are selected such that, when each of the voltages is applied to the gate of the driving transistor 12, the driving transistor 12 is turned on in a saturated region. The saturated region means a region where a current flowing through the driving transistor 12 (the driving current Iel) is kept substantially constant regardless of a voltage between the source and the drain of the driving transistor 12 (that is, regions other than a linear region where the driving current Iel depends on the voltage between the source and the drain). In other words, the saturated region is specified as a range where the following equation 1 is established between the driving current Iel flowing through the driving transistor 12 and a voltage Vgs between the gate and the source of the driving transistor 12:
Iel=β/2·(Vgs−Vth)² (1),
where ‘β’ indicates a gain coefficient of the driving transistor 12, and ‘Vth’ indicates a threshold voltage of the driving transistor 12.

The designating circuit 27 designates any one of the voltages V1 to V4 to the individual signal processing circuit 23. Meanwhile, the selecting circuit 232 of each signal processing circuit 23 selects any one of the voltages V1 to V4 output from the voltage generating circuit 25 in response to the designation of the designating circuit 27 and then outputs the selected voltage as a voltage Vsel. The voltage Vsel is applied to the gate of an i-th driving transistor 12 at a time density corresponding to the gray-scale data Gi. Next, the values of the voltages V1 to V4 and a designating method by the designating circuit 27 will be described in detail below.

The threshold voltage Vth of the driving transistor 12 or a characteristic value thereof, such as carrier mobility, is varied due to various factors, such as a manufacturing process. When the same voltage is applied to the gates of the driving transistors 12 having different characteristic values, as can be apparently seen from the equation 1, different driving currents Iel flow through the driving transistors 12.

In this embodiment, in order to compensate for the difference between the driving currents Iel, the values of the voltages V1 to V4 are selected such that the difference between the driving currents Iel flowing through the driving transistors 12 when the voltage Vsel selected from the voltages V1 to V4 according to the characteristic value of the driving transistor 12 is applied to the gates of the driving transistors 12 is smaller than the difference between the driving currents Iel flowing through the driving transistors 12 when the same voltage is applied to the gates of the driving transistors 12 (Ideally, the driving currents Iel flowing through the driving transistors 12 are substantially equal to each other).

For example, assuming that the threshold voltage Vth of a driving transistor 12a is lower than the threshold voltage Vth of a driving transistor 12b, the voltage V1 is set to be lower than the voltage V2 such that the difference between the driving current Iel when the voltage V1 is applied to the gate of the driving transistor 12a and the driving current Iel when the voltage V2 is applied to the gate of the driving transistor 12b is smaller than the difference between the driving currents Iel when the same voltage is applied to the gates of the driving transistor 12a and the driving transistor 12b (ideally, the differences are equal to each other). Ideally, it is preferable that the voltage generating circuit 25 generate voltages corresponding to the total number of driving transistors 12 (the voltages are selected to correspond to the characteristic values of the driving transistors 12). However, in this embodiment, for the purpose of simplicity of the description, it is assumed that the voltage generating circuit 25 generates only four types of voltages.

Meanwhile, the designating circuit 27 includes a memory 271. The memory 271 is a non-volatile memory which stores data (hereinafter, referred to as ‘voltage designating data’) for discriminating voltages to be selected by the selecting circuit 232 of each signal processing circuit 23, among the voltages V1 to V4 generated by the voltage generating circuit 25. The designating circuit 27 outputs the voltage designating data stored in the memory 271 to the selecting circuit 232 of each signal processing circuit 23. The selecting circuit 232 selects the voltage designated by the voltage designating data and then outputs the selected voltage as the voltage Vsel.

The generation of the voltage designating data and the storing of the voltage designating data in the memory 271 are performed before the shipment of the light emitting device D. More specifically, in order to measure a physical value (for example, the driving current Iel of the light emitting element 14 or the brightness of light emitted from the light emitting element 14) reflecting a variation in the characteristic value of each driving transistor 12, the gray-scale data G designating the gray-scale value common to all the unit circuits U is input to the driving circuit 20 to cause the light emitting element 14 to emit light. Then, a predetermined calculation is performed on the measured value, and the measured value is stored in the memory 271 as the voltage designating data.

The level shifter 233 shown in FIG. 1 shifts the voltage value of the pulse signal Sp generated by the pulse generating circuit 231 on the basis of the voltage Vsel output from the selecting circuit 232. FIG. 3 is a circuit diagram illustrating the detailed structure of the level shifter 233. As shown in FIG. 3, the voltage Vsel output from the selecting circuit 232 is input to the level shifter 233 through a buffer B.

The level shifter 233 includes two p-channel transistors Tp (Tp1 and Tp2) and two n-channel transistors Tn (Tn1 and Tn2). A source of each of the transistors Tn is connected to an output terminal of the buffer B. A source of each of the transistors Tp is connected to the power line through which the power supply voltage VEL is supplied. A drain of the transistor Tn1 is connected to a drain of the transistor Tp1 and a gate of the transistor Tp2, and a drain of the transistor Tn2 is connected to a drain of the transistor Tp2 and a gate of the transistor Tp1.

A gate of the transistor Tn2 is supplied with the pulse signal SP output from the pulse generating circuit 231, and a gate of the transistor Tn1 is supplied with a signal/SP obtained by inverting the logical level of the pulse signal SP. A connecting point between the transistor Tn2 and the transistor Tp2 serves as an output terminal Tout for a data signal Vd[i]. The output terminal Tout is connected to the gate of the driving transistor 12 of the i-th unit circuit U.

In the above-mentioned structure, when the pulse signal SP is at a high level, the transistor Tn2 is turned on. When the signal/SP is at a low level, the transistor Tn1 is turned off. In addition, when the voltage Vsel is supplied through the transistor Tn2, the transistor Tp1 is turned on. In this case, when the voltage VEL is applied to the gate of the transistor Tp2 through the transistor Tp1, the transistor Tp2 is turned off. As such, when the pulse signal SP is at the high level, the voltage Vsel supplied from the buffer B is output to the output terminal Tout through the transistor Tn2. When the voltage Vsel is supplied to the gate, the driving transistor 12 of the i-th unit circuit U is turned on in the saturated region, causing the light emitting element 14 to emit light having a brightness corresponding to the voltage Vsel (more specifically, the driving current Iel).

On the other hand, when the pulse signal SP is at the low level, the transistor Tn2 is turned off. In this case, since the signal/SP is kept at the high level, the transistor Tn1 is turned on. Then, the voltage Vsel is applied to the gate of the transistor Tp2 through the transistor Tn1, which causes the transistor Tp2 to be turned on. That is, when the pulse signal SP is at the low level, the voltage VEL is output to the output terminal Tout through the transistor Tp2. When the voltage VEL is supplied to the gate, the driving transistor 12 of the i-th unit circuit U is turned off, causing the light emitting element 14 to be turned off.

As described above, the data signal Vd[i] output from the i-th signal processing circuit 23 turns to the voltage Vsel (that is, a voltage to turn the driving transistor 12 on) within part of the unit period P corresponding to the gray-scale data Gi, and turns to the voltage VEL (that is, a voltage to turn the driving transistor 12 off) within the other part of the unit period P. That is, the pulse generating circuit 231 and the level shifter 233 according to this embodiment function as a unit (an output unit in the invention) for outputting the voltage Vsel output from the selecting circuit 232 to the gate of the driving transistor 12 of the i-th unit circuit U at the time density corresponding to the gray-scale value designated by the gray-scale data Gi.

As described above, in this embodiment, the voltage Vsel to be supplied to the gate of the driving transistor 12 is selected from the voltages V1 to V4 such that the difference between the driving current Iel generated by the driving transistors 12 of the unit circuits U is reduced. Therefore, it is possible to reduce a variation in the characteristic value of the driving transistor 12 and thus make each light emitting element 14 emit light having a predetermined brightness with high accuracy, as compared with a structure in which the common voltage is supplied to the gates of all the driving transistors 12.

Further, in this embodiment, the voltages V1 to V14 are selected such that each of the driving transistors 12 is operated in the saturated region. That is, the driving current Iel flowing through each of the driving transistors 12 depends on only the voltage between the gate and the source thereof, but does not depend on the voltage between the source and the drain thereof. Meanwhile, a variation in characteristics of each of the light emitting elements 14 occurs due to a manufacturing process, the ambient temperature of the light emitting device D, or over the passage of time. When the variation in characteristics of the light emitting element 14 occurs, the voltages between the sources and the drains of the driving transistors 12 of the unit circuits U may differ from each other. In addition, a variation in the voltage between the source and the drain of the driving transistor 12 of each unit circuit U may occur due to a variation or change in the characteristic of the driving transistor 12. However, according to this embodiment in which the driving transistor 12 is operated in the saturated region, the driving current Iel does not depend on the voltage between the source and the drain, which makes it possible to cause each light emitting element 1.4 to emit light having a predetermined brightness with high accuracy even when characteristics of the light emitting elements 14 or the driving transistors 12 of the unit circuits U differ from one another.

### Second Embodiment

Next, a second embodiment of the invention will be described below.

In the first embodiment, contents to be designated by the designating circuit 27 is previously determined according to the characteristic value of each of the driving transistors 12 which is measured, for example, before the shipment of the light emitting device D. In contrast, in the second embodiment, contents to be designated by the designating circuit 27 (that is, the voltage Vsel output from each of the selecting circuits 232) is changed whenever necessary according to the actual usage environment of a light emitting device D. Further, in the second embodiment, the same components as those in the first embodiment have the same reference numerals, and thus a description thereof will be omitted for the purpose of simplicity.

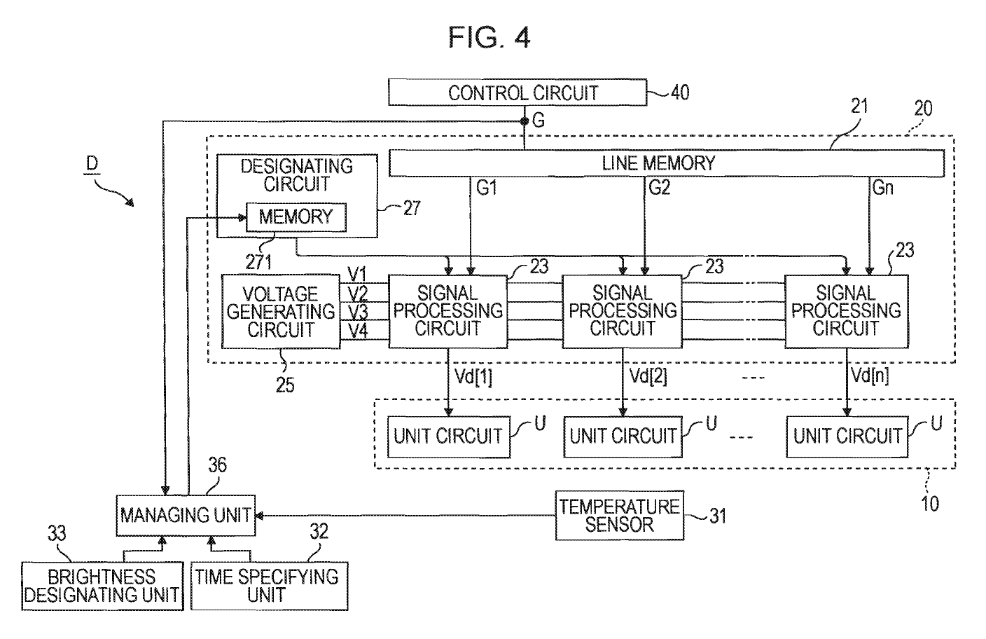

FIG. 4 is a block diagram illustrating the structure of the light emitting device D according to the second embodiment of the invention. The light emitting device D includes a temperature sensor 31, a time specifying unit 32, a brightness designating unit 33, and a managing unit 36, in addition to the components shown in FIG. 1. The functions of the time specifying unit 32, the brightness designating unit 33, and the managing unit 36 may be executed by hardware, such as a digital signal processor (DSP), or by a program that is performed by a computer such as a central processing unit (CPU).

The temperature sensor 31 functions to detect the temperature of a light emitting unit 10 (including light emitting elements 14) or the ambient temperature thereof. The time specifying unit 32 counts the sum of time lengths which are previously used by the light emitting device D (the sum of time lengths from the turning-on of a power supply to the turning-off of the power supply; hereinafter, referred to as ‘cumulative usage time’) and stores the counting result.

The brightness designating unit 33 is a unit for designating the overall brightness of the light emitting unit 10. The brightness designating unit 33 of this embodiment designates the brightness of the light emitting unit 10 when a user operates a specific operator (an operator for adjusting the brightness of the light emitting unit 10). In addition, the brightness designating unit 33 designates the brightness of the light emitting unit 10 according to the quantity of external light, such as sunlight or illumination light. For example, the brightness designating unit 33 designates low brightness, on the basis of signals output from a sensor (not shown) for detecting the quantity of external light, when the quantity of external light is large. On the other hand, when the quantity of external light is small, the brightness designating unit 33 designates high brightness.

The managing unit 36 updates the voltage designating data stored in the memory 271 on the basis of various information items, such as the temperature detected by the temperature sensor 31 and the cumulative usage time specified by the time specifying unit 32. The update may be performed whenever power is supplied to the light emitting device D, or whenever the user inputs instructions. Alternatively, the voltage designating data may be updated in a mode in which the operation of the light emitting device D pauses. The managing unit 36 is operated according to the following processes (1) to (4).

(1) The managing unit 36 updates the voltage designating data stored in the memory 271 according to the temperature detected by the temperature sensor 31. The voltage designating data corresponding to temperatures is experimentally determined beforehand such that, even when the light emitting elements 14 are used below the corresponding temperatures they emit light having target brightness without depending on the temperature. The managing unit 36 holds a table where the temperatures and the voltage designating data stored in the memory 271 at the temperatures are associated with each other. The managing unit 36 retrieves the voltage designating data corresponding to the actual temperature on the basis of the table and then outputs the voltage designating data to the memory 271. Alternatively, the managing unit 36 may calculate the voltage designating data after the update by performing a predetermined calculation on the temperature detected by the temperature sensor 31.

(2) The managing unit 36 updates the voltage designating data stored in the memory 271 according to the cumulative usage time specified by the time specifying unit 32. The voltage designating data corresponding to each cumulative usage time is experimentally determined beforehand such that, even when each cumulative usage time is elapsed, each light emitting element 14 emits light having target brightness without depending on the cumulative usage time. The managing unit 36 holds a table where the cumulative usage time and the voltage designating data are associated with each other. The managing unit 36 retrieves the voltage designating data corresponding to the cumulative usage time actually specified by the time specifying unit 32 from the table and then outputs the voltage designating data to the memory 271. Alternatively, the managing unit 36 may calculate new voltage designating data by performing a predetermined calculation on the cumulative usage time specified by the time specifying unit 32.

(3) The managing unit 36 updates the voltage designating data stored in the memory 271 according to the brightness designated by the brightness designating unit 33. The voltage designating data corresponding to brightness is specified by a table where the brightness and the voltage designating data are associated with each other or by performing a predetermined calculation on the brightness. For example, the managing unit 36 updates the voltage designating data corresponding to each signal processing circuit 23 such that the higher the brightness designated by the brightness designating unit 33 is, the higher the voltage designated to each selecting circuit 232 by the designating circuit 27 becomes. According to this structure, as the brightness designated by the brightness designating circuit 33 becomes lower (that is, when the user designates low brightness or when the quantity of external light is small), the brightness of light emitted from the light emitting element 14 becomes lower.

(4) The managing unit 36 updates the voltage designating data stored in the memory 271 on the basis of the gray-scale data G output from the control circuit 40. More specifically, the managing unit 36 calculates the average value of the gray-scale values of n gray-scale data G (G1 to Gn) supplied from the control circuit 40 and updates the voltage designating data stored in the memory 271 on the basis of the average value. The voltage designating data corresponding to the aver-ace value is specified by a table where the average value and the voltage designating data are associated with each other in advance or by performing a predetermined calculating process on the average value. In this embodiment, the managing unit 36 updates the voltage designating data corresponding to the average value of the gray-scale values. However, the managing unit 36 may retrieve a maximum value of the gray-scale values from the n gray-scale data G and then update the voltage designating data on the basis of the maximum value.

As described above, according to this embodiment, the voltage Vsel applied to the gate of each of the driving transistors 12 is adjusted on the basis of the temperature of the light emitting device 10. Therefore, even when the characteristics of the driving transistors 12 or the light emitting elements 14 change according to the temperature, it is possible to make the light emitting elements 14 emit light having a predetermined brightness. Further, in this embodiment, the voltage Vsel applied to the gate of each of the driving transistors 12 is adjusted according to the cumulative usage time. Therefore, even when the characteristics of the driving transistors 12 or the light emitting elements 14 change according to the temperature, it is possible to make the light emitting elements 14 emit light having a predetermined brightness.

Furthermore, in this embodiment, the voltage Vsel applied to the gate of each of the driving transistors 12 is variable. Therefore, as described above, it is possible to reliably adjust the overall brightness of the light emitting unit 10 with a simple structure on the basis of the gray-scale data G supplied from the control circuit 40 or the brightness designated by the brightness designating unit 33.

Further, in this embodiment, the voltage Vsel of the data signal Vd[i] is adjusted according to the above-mentioned processes (1) to (4). However, the voltage Vsel of the data signal Vd[i] may be adjusted according to any one of the above-mentioned processes (1) to (4). In addition, in this embodiment, the voltage designating data stored in the memory 271 is updated on the basis of factors, such as, the temperature or the cumulative usage time. However, an operation of updating data may not necessarily be needed as long as the voltage Vsel designated to the selecting circuit 232 by the designating circuit 27 can be chanced by these factors.

Modifications

Various modifications of the above-described embodiments can be made. The following modifications can be given as examples. Also, the following modifications can be properly combined with one another.

First Modification

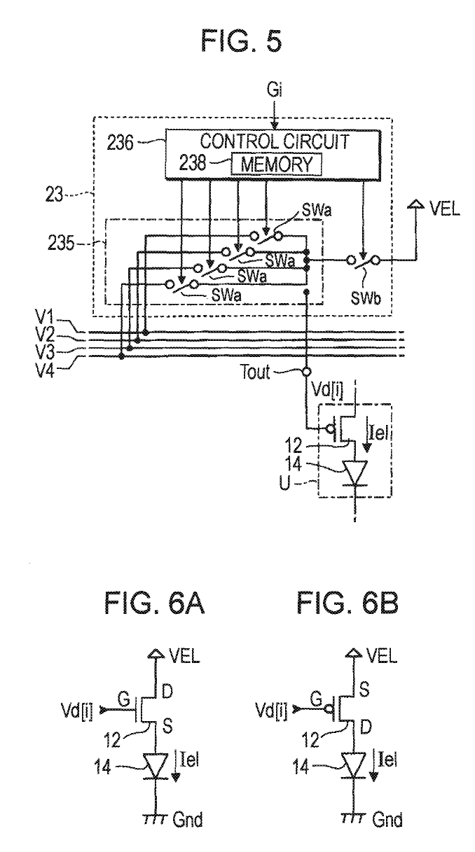

The structures of the components shown in FIG. 1 arbitrarily change. For example, each of the signal processing circuits 23 may be formed in a structure shown in FIG. 5. The signal processing circuit 23 shown in FIG. 5 (in this modification, an i-th signal processing circuit 23 is given as an example) includes a selecting circuit 235, a switch SWb, and a control circuit 236. In the structure shown in FIG. 5, the designating circuit 27 shown in FIG. 5 is omitted from the signal processing circuit 23.

The selecting circuit 235 includes four switches SWa corresponding to voltages V1 to V4. One end of each of the switches SWa is connected to a common output terminal Tout for a data signal Vd[i]. The other ends of the switches SWa are connected to wiring lines through which the voltages (V1 to V4) corresponding to the switches SWa are supplied. Meanwhile, one end of the switch SWb is connected to a power line through which a power supply voltage VEL is supplied, and the other end thereof is connected to the output terminal Tout.

The control circuit 236 controls the selecting circuit 235 and the switch SWb on the basis of gray-scale data Gi supplied from a line memory 21, and includes a memory 238 for storing voltage designating data designating any one of the voltages V1 to V4, similar to the designating circuit 27 according to the first embodiment. The voltage designated by the voltage designating data is selected for every signal processing circuit 23 according to the characteristic value of each driving transistor 12 such that a driving current Iel of each unit circuit U is made constant when the voltage is applied to the gate of the driving transistor 12.

The operations of the control circuit 236 are classified into two operations: a first operation within part of a unit period P (hereinafter, referred to as a ‘first period’) corresponding to the gray-scale value designated by the gray-scale data Gi; and a second operation within the other part of the unit period (hereinafter, referred to as a ‘second period’). From a starting point to an ending point of the first period, the control circuit 236 turns on the switch SWa corresponding to the voltage designated by the voltage designating data stored in the memory 238 and turns off the other switches SWa and the switch SWb. Then, in the first period, any one of the voltages V1 to V4 is output to the unit circuit U as the data signal Vd[i]. From a starting point to an ending point of the second period, the control circuit 236 turns off all of the switches SWa of the selecting circuit 235 and turns on the switch SWb. Then, in the second period, the voltage VEL is output to the unit circuit U as the data signal Vd [i] Therefore, in the structure shown in FIG. 5 the data signal Vd having the same waveform as that in the first embodiment is also generated.

As described above, it does not matter how to form a unit for outputting the voltage Vsel to the gate of the driving transistor 12 at the time density corresponding to the gray-scale data G. The output unit of the invention corresponds to the pulse generating circuit 231 and the level shifter 233 according to the first and second embodiments and the control circuit 236 and the switch SWb shown in FIG. 5.

In the first and second embodiments and the structure shown in FIG. 5, any one of a plurality of voltages V1 to V4 generated by the voltage generating circuit 25 is selected. However, the voltage generating circuit 25 may generate the voltage Vsel corresponding to the characteristic of the driving transistor 12 and the voltage Vsel may be individually supplied to the signal processing circuit 23 corresponding to the driving transistor 12. That is, in the invention, selecting any one of the plurality of voltages is not necessarily performed, but a voltage adjusting unit (corresponding to the voltage generating circuit 25 and the selecting circuits 232 in the first embodiment) for variably outputting a voltage designated by the designating circuit 27 may be provided.

Second Modification

The structure of the driving transistor 12 arbitrarily changes. That is, the driving transistor 12 may be a thin film transistor or a so-called bulk transistor (MOS-FET). In the above-described embodiments, the driving transistor 12 is formed of a p-channel transistor. However, the driving transistor 12 may be formed of an n-channel transistor. In this case, it is possible to compensate for a variation in the initial characteristics of the light emitting element 14 or a variation in the characteristics of the driving transistor 12, similar to the first embodiment. However, the above-described embodiments in which the driving transistor 12 is formed of the p-channel transistor also have an advantage in that it is possible to compensate for a variation in the characteristics of the light emitting element 14 over the passage of time, as described above.

In the structure in which the driving transistor 12 is formed of the n-channel transistor, as shown in FIG. 6A, the source of the driving transistor 12 is connected to the anode of the light emitting element 14. In this structure, for example, when the threshold voltage of the light emitting element 14 rises over the passage of time, the voltage of the source of the driving transistor 12 also rises. The driving current Iel determined by the voltage between the gate and the source varies over the passage of time according to a variation in the characteristics of the light emitting element 14. In contrast, as shown in FIG. 6B, the p-channel driving transistor 12 has a drain connected to the anode of the light emitting element 14 and a source connected to the power line. In this structure, even when the voltage of the anode of the light emitting element 14 varies over the passage of time, the voltage between the gate and the source of the driving transistor 12 does not vary at all. Therefore, the structure using the p-channel driving transistor 12 has an advantage in that the driving current Iel is kept substantially constant regardless to a variation in the characteristics of the light emitting element 14.

Third Modification

In the above-described embodiments, the light emitting device D having a plurality of unit circuits U arranged in a row is provided. A light emitting device D having a plurality of unit circuits U arranged in a matrix may be provided. In this case, the unit circuits U are provided at intersections of a plurality of scanning lines and a plurality of data lines. In addition, a scanning line driving circuit line-sequentially selects rows of unit circuits U, and the driving circuit 20 (in this structure, a data line driving circuit) performs the same operations as those in the first and second embodiments on the selected row of unit circuits U.

Further, in the above-described embodiments, the voltage Vsel to be applied to the gate of the driving transistor 12 is selected for every unit circuit U. However, the range of a unit where the voltage of the gate of the driving transistor 12 is adjusted is not limited thereto. For example, in a structure in which a plurality of unit circuits U are arranged in a matrix, the voltage of the gate of the driving transistor 12 may be adjusted for every row of unit circuits arranged along a scanning line or a data line (that is the common voltage Vsel is applied to the gates of the transistors 12 belonging to the same row or column of unit circuits U).

Fourth Modification

In the first embodiment, the voltage designating data generated according to the result measured before the shipment of the light emitting device D is stored in the memory. The same operation may be performed at any timing after the shipment. In this case, the above-mentioned structure includes an apparatus for measuring characteristic values (for example, the brightness of each light emitting element 14 or the driving current Iel supplied to each light emitting element 14) reflecting the characteristics of each driving transistor 12 and a unit for generating the voltage designating data corresponding to the unit circuits U by performing a predetermined calculation using the measured values and for storing the voltage designating data in the memory 271. The measurement or update of the voltage designating data may be performed whenever the power supply for the light emitting device D is turned on or during the operation of the light emitting device D.

Fifth Modification

In the above-described embodiments and modifications, the light emitting device D using OLED elements is provided. However, a light emitting device using elements other than the OLED elements may be used. For example, the invention can be applied to various light emitting devices, such as a display device using inorganic electro-luminescent (EL) elements, a field emission display (FED, device, a surface-conduction electron-emitter display (SED) device, a ballistic electron surface emitting display (BSD) device, and a display device using light emitting diodes.

Applications

In the above-described embodiments, the light emitting device which is used as an exposure device for an image forming apparatus is given as an example, but the light emitting device of the invention can be applied to devices other than the exposure device. For example, a light emitting device having a plurality of unit circuits arranged in a matrix can be used as a device for displaying various images. The light emitting device of the invention can be applied to the following electronic apparatuses.

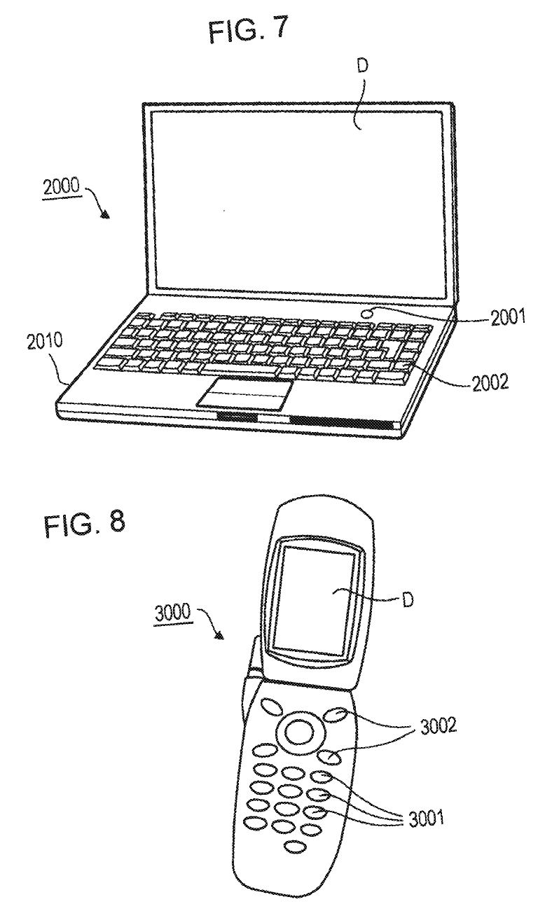

FIG. 7 is a perspective view illustrating the structure of a portable personal computer using the light emitting device D according to any one of the above-described embodiments as a display device. A personal computer 2000 as the light emitting device D, serving as a display device, and a main body 2010. The main body 2010 is provided with a power supply switch 2001 and a keyboard 2002. Since the light emitting device D uses OLED elements as the light emitting elements 14, an image can be displayed on a screen with a wide viewing angle.

FIG. 8 shows the structure of a cellular phone using the light emitting device D according to any one of the above-described embodiments. A cellular phone 3000 includes a plurality of operating buttons 3001 and scroll buttons 3002, and the light emitting device D, serving as a display device. The scroll button 3002 is operated to scroll a screen displayed on the light emitting device D.

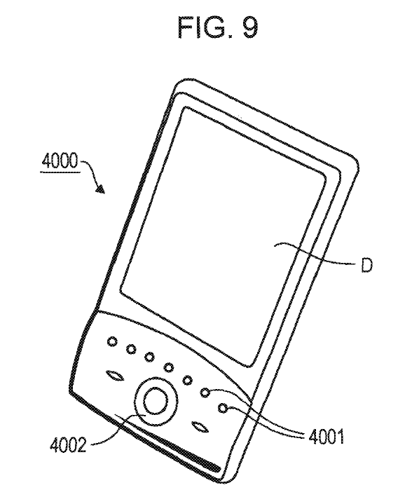

FIG. 9 shows the structure of a personal digital assistant (PDA) using the light emitting device D according to any one of the above-described embodiments. A personal digital assistant 4000 includes a plurality of operating buttons 4001, a power supply switch 4002, and the light emitting device D serving as a display device. The power supply switch 4002 is operated to display various kinds of information items, such as an address book and a schedule book, on the light emitting device D.

Further, the light emitting device D according to the invention can be applied to various electronic apparatuses, such as a digital still camera, a television, a video camera, a car navigation apparatus, a pager, an electronic organizer, an electronic paper, an electronic calculator, a word processor, a workstation, a television phone, a POS terminal, a printer, a scanner, a duplicating machine, a video player, and apparatuses equipped with touch panels, in addition to the electronic apparatuses shown in FIGS. 7 to 9.

What is claimed is:

1. A light emitting device, comprising:
a plurality of unit circuits, each of the unit circuits including a driving transistor, having a gate, to generate a driving current corresponding to a potential of the gate, and a light emitting element to emit light having a brightness corresponding to the driving current;
a plurality of signal processing units corresponding to the unit circuits; and
a designating unit that designates voltages to the signal processing units;
each of the plurality of signal processing units including:
a voltage adjusting unit that variably outputs a voltage to operate the driving transistor, of one of the plurality of unit circuits, in a saturated region in response to a designation by the designating unit; and
an output unit that outputs the voltage output from the voltage adjusting unit to the gate of the driving transistor, of one of the plurality of unit circuits, corresponding to one of the plurality of signal processing units at a time density corresponding to a gray-scale value designated to the light emitting element of one of the plurality of unit circuits.

2. The light emitting device according to claim 1,
the designating unit designating a voltage corresponding to a characteristic of the driving transistor of one of the plurality of unit circuits to the signal processing unit corresponding to the one unit circuit.

3. The light emitting device according to claim 2,
when a common gray-scale value is designated to a first unit circuit and a second unit circuit among the plurality of unit circuits, the designating unit designating different voltages to the signal processing unit corresponding to the first unit circuit and the signal processing unit corresponding to the second unit circuit, such that the driving currents generated by the driving transistors of the first unit circuit and the second unit circuit are substantially equal to each other.

4. The light emitting device according to claim 1, further comprising:
a temperature sensor that detects at least one of a temperature of each of the plurality of unit circuits and an ambient temperature of each of the plurality of unit circuits,
the designating unit designating a voltage corresponding to the temperature detected by the temperature sensor.

5. The light emitting device according to claim 1, further comprising:
a time specifying unit that specifies a time length used by the light emitting devices
the designating unit designating a voltage corresponding to the time length specified by the time specifying unit.

6. The light emitting device according to claim 1, further comprising:
a brightness designating unit that designates an overall brightness of the plurality of light emitting elements,
the designating unit designating a voltage corresponding to the overall brightness designated by the brightness designating unit.

7. The light emitting device according to claim 1,
the designating unit designating a voltage corresponding to the gray-scale value designated to each of the plurality of light emitting elements.

8. The light emitting device according to claim 1,
the voltage adjusting unit of each of the signal processing units including:
a voltage generating circuit that generates a plurality of voltages having different levels; and
a selecting circuit that selects one of the plurality of voltages designated by the designating unit.

9. The light emitting device according to claim 1,
the designating unit including a storage unit that stores a voltage to be output by the voltage adjusting unit of one of the plurality of signal processing units, and
the designating unit designating a voltage to each of the signal processing units based on contents stored in the storage unit.

10. A light emitting device, comprising:
a plurality of driving transistors, each of the driving transistors having a gate and generating a driving current corresponding to a potential of the gate;
a plurality of light emitting elements, each of the light emitting elements emitting light having a brightness corresponding to the driving current;
a designating unit that designates a voltage;
a plurality of voltage adjusting units, each of the voltage adjusting units variably outputting a voltage to operate one of the plurality of driving transistors in a saturated region in response to a designation by the designating unit; and
a plurality of output units, each of the output units outputting the voltage output from one of the plurality of voltage adjusting units to the gate of one of the plurality of driving transistors at a time density corresponding to a gray-scale value designated to one of the plurality of light emitting element.

11. An electronic apparatus, comprising:
the light emitting device according to claim 1.

12. A circuit that drives a light emitting device including a plurality of unit circuits, each of the unit circuits including a driving transistor, having a gate, to generate a driving current corresponding to a potential of the gate, and a light emitting element to emit light having a brightness corresponding to the driving current, the circuit comprising:
a plurality of signal processing units that correspond to the unit circuits; and
a designating unit that designates voltages to the signal processing units;
each of the plurality of signal processing units including:
a voltage adjusting unit that variably outputs a voltage to operate the driving transistor, of one of the plurality of unit circuits, in a saturated region in response to a designation by the designating unit; and
an output unit that outputs the voltage output from the voltage adjusting unit to the gate of the driving transistor, of one of the plurality of unit circuits, corresponding to one of the plurality of signal processing units at a time density corresponding to a gray-scale value designated to the light emitting element of one of the plurality of unit circuits.
